(19) United States
(12) Patent Application Publication
(10) Pub. No.: US 2026/0261984 A1
(43) Pub. Date: Sep. 3, 2026

(54) POWER LEVEL STATISTICS AND POWER LEVEL ADJUSTMENTS WITHIN A SPECIFIC ABSORPTION RATE TIME WINDOW

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/067,499

(22) Filed: Feb. 28, 2025

(51) Int. Cl. H04W 52/14; H04L 5/00; H04W 52/36; H04W 72/21

(52) U.S. Cl. CPC H04W 52/146; H04L 5/0048; H04W 52/365; H04W 72/21

(57) ABSTRACT

Various aspects of the present disclosure generally relate to wireless communication. In some aspects, a user equipment (UE) may transmit, within a specific absorption rate (SAR) time window, a first uplink transmission using a first transmit power level that is higher than a maximum transmit power associated with the UE, the first uplink transmission indicating at least one of: one or more transmit power level statistics, or one or more planned transmit power levels that are based at least in part on at least one of: a scheduling rate, or a duty cycle. The UE may transmit a second uplink transmission using a second transmit power level that is lower than a configured transmit power level for the second uplink transmission, where the second transmit power level is based at least in part on the first transmit power level and satisfying an SAR threshold. Numerous other aspects are described.

### FIELD OF THE DISCLOSURE

Aspects of the present disclosure generally relate to wireless communication and specifically relate to techniques, apparatuses, and methods associated with power level statistics and power level adjustments within a specific absorption rate time window.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Because a user equipment (UE) may emit radio frequency (RF) waves, microwaves, and/or other radiation, UEs are generally subject to regulatory RF safety requirements that set forth specific guidelines, or exposure limits, that constrain various operations that the UEs can perform. For example, RF emissions may generally increase when a UE is transmitting, and the RF emissions may further increase in cases where the UE is performing frequent transmissions, high-power transmissions, or the like. Accordingly, because frequent and/or high-power transmissions may lead to significant RF emissions, regulatory agencies may provide information related to acceptable RF radiation exposure when UEs are communicating using different radio access technologies. One such example is a specific absorption rate (SAR), which measures energy absorption by human tissue per unit mass and may have units of watts per kilogram (W/kg). To illustrate, a regulatory agency may specify an SAR operating condition that an average transmit power level by a UE satisfies (e.g., does not exceed) an SAR threshold for a particular time window (e.g., an SAR time window).

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include transmitting, within a specific absorption rate (SAR) time window, a first uplink transmission using a first transmit power level that is higher than a maximum power threshold that is indicated to the UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The method may include transmitting, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

Some aspects described herein relate to a method of wireless communication performed by a network node. The method may include receiving, within an SAR time window, a first uplink transmission that uses a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The method may include receiving, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold.

Some aspects described herein relate to a non-transitory computer-readable medium that stores a set of instructions for wireless communication by a UE. The set of instructions, when executed by one or more processors of the UE, may cause the UE to transmit, within an SAR time window, a first uplink transmission using a first transmit power level that is higher than a maximum transmit power that is indicated to the UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The set of instructions, when executed by one or more processors of the UE, may cause the UE to transmit, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

Some aspects described herein relate to a non-transitory computer-readable medium that stores a set of instructions for wireless communication by a network node. The set of instructions, when executed by one or more processors of the network node, may cause the network node to receive, within an SAR time window, a first uplink transmission that uses a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The set of instructions, when executed by one or more processors of the network node, may cause the network node to receive, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold.

Some aspects described herein relate to an apparatus for wireless communication. The apparatus may include means for transmitting, within an SAR time window, a first uplink transmission using a first transmit power level that is higher than a maximum power threshold that is indicated to the apparatus or associated with a UE power class of a UE associated with the apparatus, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The apparatus may include means for transmitting, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

Some aspects described herein relate to an apparatus for wireless communication. The apparatus may include means for receiving, within an SAR time window, a first uplink transmission that uses a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The apparatus may include means for receiving, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold.

Some aspects described herein relate to a UE. The UE may include a processing system. The processing system may include one or more processors and one or more code-storing memories coupled with the one or more processors. The processing system may be configured to cause the UE to transmit, within an SAR time window, a first uplink transmission using a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The processing system may be configured to cause the UE to transmit, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

Some aspects described herein relate to a network node. The network node may include a processing system. The processing system may include one or more processors and one or more code-storing memories coupled with the one or more processors. The processing system may be configured to cause the network node to receive, within an SAR time window, a first uplink transmission that uses a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The processing system may be configured to cause the network node to receive, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A and 3B are diagrams illustrating a first example of processes that may be used to select a downlink precoding matrix and a second example of a comparison between the processes, respectively.

FIG. 4 is a diagram illustrating an example of adapting a transmit power level over a moving integration window to satisfy one or more radio frequency radiation exposure limits.

FIG. 5 is a diagram illustrating an example of a wireless communication process between a network node and a user equipment (UE).

FIG. 6 is a diagram illustrating a table of example transmit power level statistics.

FIG. 7 is a diagram illustrating an example process performed, for example, at a UE or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

In a multiple-input, multiple-output (MIMO) system, a transmitter and receiver may simultaneously communicate one or more data streams with one another using multiple antennas. As one example, the transmitter may use beamforming to simultaneously transmit a first data stream via a first beam and a second data stream via a second beam. To beamform the data streams via separate beams, the transmitter may apply a first set of precoding weights to a first signal associated with the first data stream such that antennas of an antenna array transmit respective weighted portions of the first signal that, when combined, form the first beam. Similarly, the transmitter may apply a second set of precoding weights to a second signal associated with the second data stream such that antenna of the antenna array transmit respective weighted portions of the second signal that, when combined, form the second beam.

In some cases, a transmitter in the form of a network node may compute the precoding weights based at least in part on a sounding reference signal (SRS) and an expectation of channel reciprocity in a time division duplexing (TDD) system. “Precoding weight mismatch” denotes a deviation from a first channel response, which is used to compute a set of precoding weights, and a second channel response through which a transmission that generated using the precoding weights propagates. That is, the precoding weights may be optimized for the first channel response, but may be used to generate a transmission that propagates through a channel that has a second channel response that deviates from the first channel response, and the deviation between the channel responses may result in precoding weights that are less effective at mitigating interference, directing a beam to a desired location, or a combination of the two. Accordingly, uplink channel estimation computed by a network node may be heavily influenced by a quality of an SRS received by the network node.

Because a user equipment (UE) may emit radio frequency (RF) waves, microwaves, and/or other radiation, UEs are generally subject to regulatory RF safety requirements that set forth specific guidelines, or exposure limits, that constrain various operations that the UEs can perform. For example, RF emissions may generally increase when a UE is transmitting, and the RF emissions may further increase in cases where the UE is performing frequent transmissions, high-power transmissions, or the like. Accordingly, because frequent and/or high-power transmissions may lead to significant RF emissions, regulatory agencies may provide information related to acceptable RF radiation exposure when UEs are communicating using different radio access technologies. One such example is a specific absorption rate (SAR), which measures energy absorption by human tissue per unit mass and may have units of watts per kilogram (W/kg). To illustrate, a regulatory agency may specify an SAR operating condition that an average transmit power level by a UE satisfies (e.g., does not exceed) an SAR threshold for a particular time window (e.g., an SAR time window).

A UE satisfying an SAR operating condition may result in decreased signal quality of an SRS transmitted by the UE (e.g., a reduced transmit power level, a reduced signal-to-noise ratio (SNR), or a combination thereof), and received at a network node, resulting in less accurate channel estimations, less accurate measurement metrics, or a combination thereof. The less accurate channel estimations, or the less accurate measurement metrics, may lead to uplink scheduling or downlink scheduling with increased precoding weight mismatches, reduced signal quality, or a combination of the two, that leads to increased data recovery errors, reduced data throughput, or increased data transfer latencies. To mitigate decreased SRS quality, a UE may include support for SAR-compliant power level management, which may also be referred to as “smart transmission.” As at least part of SAR-compliant power level management, a UE may selectively increase a first transmit power level of a first uplink transmission above a first configured transmit power level for the first transmission, and may selectively reduce a second transmit power level of a second transmission below a second configured transmit power level for the second level in a manner that results in SAR compliance. To illustrate, the UE may selectively increase a first transmit power level of a first transmission that is an SRS transmission as the first transmission within an SAR time window to increase an SRS quality received by the network node to increase an accuracy of an uplink channel estimation or measurement metrics. Other examples may include the UE selectively increasing a transmit power level of a physical uplink control channel (PUCCH) that carries acknowledgement (ACK) feedback and/or negative acknowledgement (NACK) feedback to ensure that the ACK/NACK feedback is decoded successfully. The UE may selectively reduce a second power level of a physical uplink shared channel (PUSCH) transmission that occurs within the same SAR time window and is an incoming part of the SAR time window to ensure that an average transmit power level of the SRS transmission and the PUSCH transmission satisfy the SAR operating condition.

In some cases, a UE may autonomously perform SAR-compliant power level management without transmitting an indication to a network node, which may result in the network node generating an SRS measurement metric using SRS with the increased power level. While the increased SRS power level may increase an accuracy of a channel estimation generated by the network node, the measurement metric generated using the SRS with the increased power level may also result in the network node scheduling a subsequent uplink transmission using an aggressive scheduling configuration that results in increased recovery errors, decreased data throughput, or increased data transfer latencies. For instance, based at least in part on the autonomously increased transmit power level being unknown to the network node, the network node may schedule the subsequent uplink transmission with an increased modulation coding scheme (MCS) or an increased quantity of MIMO layers relative to scheduling the subsequent uplink transmission based at least in part on measurement metrics for an SRS that does not include the increased power level. In some cases, the subsequent uplink transmission may occur in a same SAR time window as the SRS with increased power level, and the UE may autonomously reduce, without notifying the network node, a transmit power level of the subsequent uplink transmission to maintain SAR compliance. The increased MCS, the increased quantity of MIMO layers, the reduced transmit power level of the subsequent uplink transmission (e.g., in the same SAR time window), or any combination thereof, may increase data recovery errors, decrease data throughput, increase a data transfer latency, or any combination thereof.

Various aspects relate generally to power level statistics and power level adjustments within an SAR time window. Some aspects more specifically relate to a UE notifying a network node of transmit power level adjustments by the UE based at least in part on an SAR-compliant power level management capability of the UE. In some aspects, a UE may transmit, within an SAR time window, a first uplink transmission using a first transmit power level that is higher than a maximum transmit power that is indicated to a UE or is associated with a UE power class of the UE, such as a configured uplink power level or a maximum power level that is specified for a UE power class. In some aspects, the UE may indicate, in the first uplink transmission, at least one of: one or more transmit power level statistics that are associated with the SAR time window, or one or more planned transmit power levels, the one or more planned transmit power levels being based at least in part on at least one of: one or more scheduling rates, or one or more duty cycles. For instance, the UE may indicate a respective increased power level, a respective decreased power level, or any combination, for one or more uplink transmissions that occur within the SAR time window. Based at least in part on transmitting the first uplink transmission with an increased power level, the UE may transmit, within the SAR time window, a second uplink transmission using a second transmit power level that is based at least in part on the first transmit power level and satisfying an SAR threshold. For instance, the UE may reduce a power level of the second uplink transmission based at least in part on the second uplink transmission being an incoming part of the SAR time window. In some aspects, the UE may autonomously reduce the transmit power level of the second uplink transmission, and in other aspects, the UE may receive scheduling information that indicates a transmit power level for the second uplink transmission that is configured to satisfy the SAR threshold without autonomous power reduction by the UE.

In some aspects, a network node may receive, within an SAR time window, a first uplink transmission that uses a first transmit power level that is higher than a maximum transmit power that is indicated to a UE or is associated with a UE power class of the UE. The first uplink transmission may indicate at least one of: one or more transmit power level statistics that are associated with the SAR time window, or one or more planned transmit power levels, the one or more planned transmit power levels being based at least in part on at least one of: one or more scheduling rates, or one or more duty cycles. The network node may receive, within the SAR time window, a second uplink transmission that is associated with the UE, and the second uplink transmission may be based at least in part on a second transmit power level that is based at least in part on the first transmit power level and satisfying an SAR threshold. In some cases, prior to receiving the second uplink transmission, the network node may transmit scheduling information that indicates to use the second transmit power level for the second uplink transmission, where the second transmit power level is based at least in part on the first transmit power level and satisfying the SAR threshold. To illustrate, based at least in part on receiving the indication of the transmission power level statistics, the network node may select the second transmit power level, and instruct the UE to use the second power level.

Particular aspects of the subject matter described in this disclosure can be implemented to realize one or more of the following potential advantages. In some examples, by a UE indicating transmit power level statistics for an SAR window (e.g., transmit power level statistics that are based at least in part on an SAR-compliant power level management capability of the UE), the described techniques can be used to enable a network node to modify a transmit power level at the UE in a manner that maintains SAR compliance and mitigates a mismatch between the network node and the UE. More particularly, the indication of transmit power level statistics mitigates the network node selecting a scheduling configuration that results in recovery errors, such as the scheduling configuration with an increased MCS, increased quantity of MIMO layers, or a combination of the two, as described above. Alternatively, or additionally, the network node may select scheduling information for a subsequent uplink transmission within the SAR time window based at least in part on an expectation that the subsequent uplink transmission will have a reduced transmit power level to maintain SAR compliance. For instance, the network node may select, as at least part of the scheduling information, the reduced transmit power level, a MCS that is based at least in part on the reduced transmit power level, a quantity of MIMO layers that is based at least in part on the reduced transmit power level, or any combination thereof. In such a manner, the network node and the UE may mitigate recover errors, increase data throughput, and reduce data transfer latencies. For instance, the UE increasing a transmit power level of a PUCCH transmission may increase a probability that ACK/NACK notifications are recovered properly, resulting in an increased reliability of communications and increased resource usage efficiency. Alternatively, or additionally, the UE increasing a transmit power level of an SRS transmission may increase a quality or accuracy of an SRS-based measurement at the network node (e.g., an SRS signal-to-interference-plus-noise ratio (SINR) measurement), or a quality or accuracy of an uplink channel estimation, and may indicate to not use the increased transmit power level to schedule a subsequent uplink transmission. An increased accuracy of the uplink channel estimation may reduce precoding weight mismatch at the network node and increase SRS-based downlink MIMO performance (e.g., reduced recovery errors, increased data throughput, or reduced data transfer latencies). Alternatively, or additionally, indicating to not use the increased transmit power level to schedule a subsequent uplink transmission may also mitigate the network node selecting an aggressive scheduling configuration, resulting in reduced recovery errors, increased data throughput, and reduced data transfer latencies.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

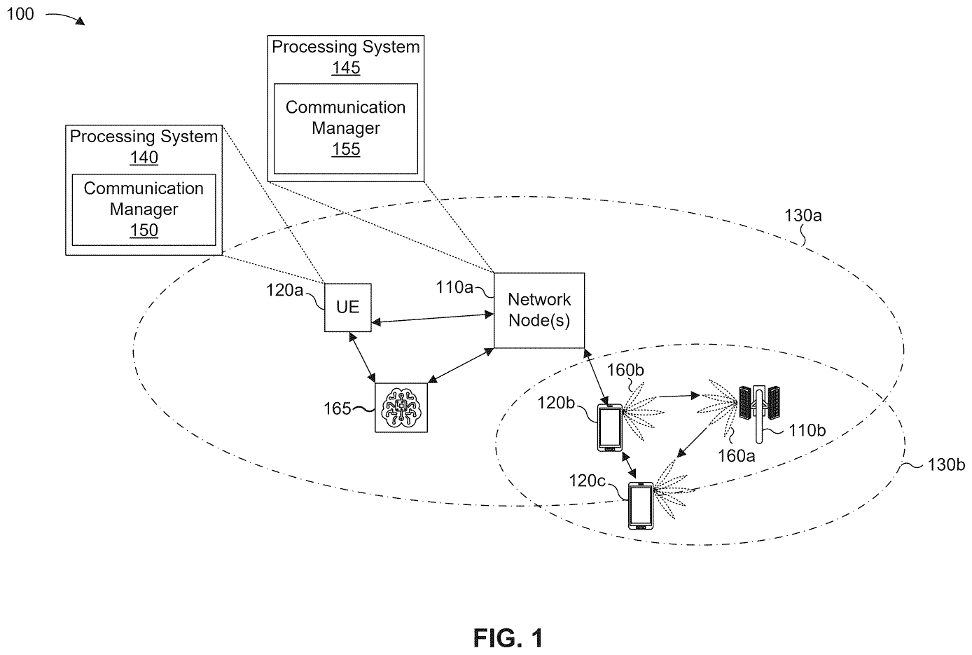

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include PUCCHs, and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, the communication manager 150 may transmit, within an SAR time window, a first uplink transmission using a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles.; and transmit, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold. Additionally, or alternatively, the communication manager 150 may perform one or more other operations described herein.

In some aspects, a network node (e.g., a network node 110) may include a communication manager 155. As described in more detail elsewhere herein, the communication manager 155 may receive, within an SAR time window, a first uplink transmission that uses a first transmit power level that is higher than a maximum transmit power that is indicated to a UE or is associated with a UE power class of the UE, the first uplink transmission indicating one or more transmit power level statistics that are associated with the SAR time window; and receive, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold. Additionally, or alternatively, the communication manager 155 may perform one or more other operations described herein.

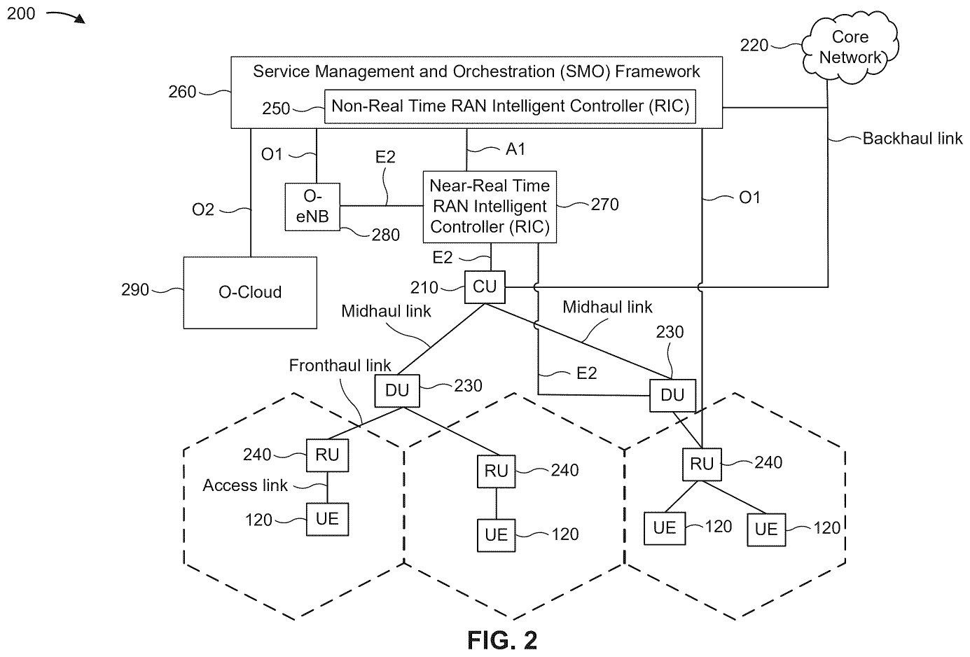

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

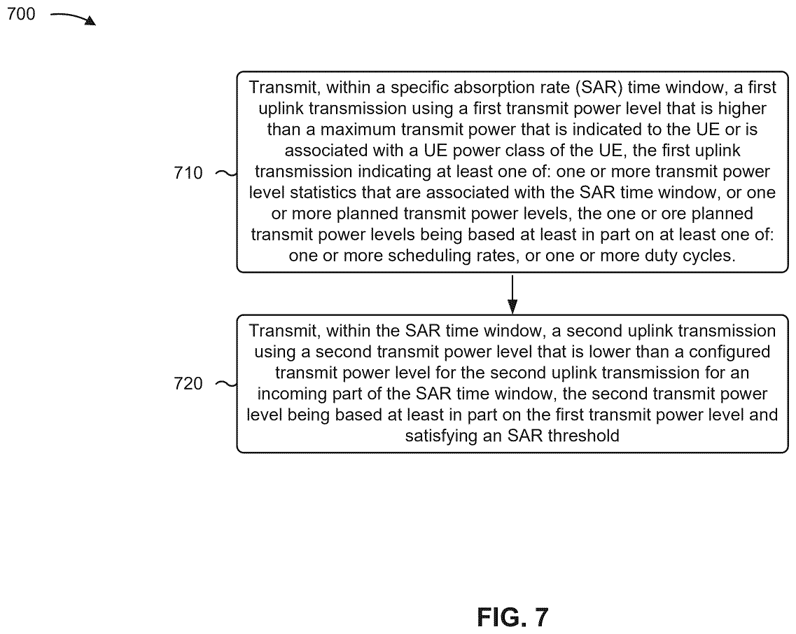

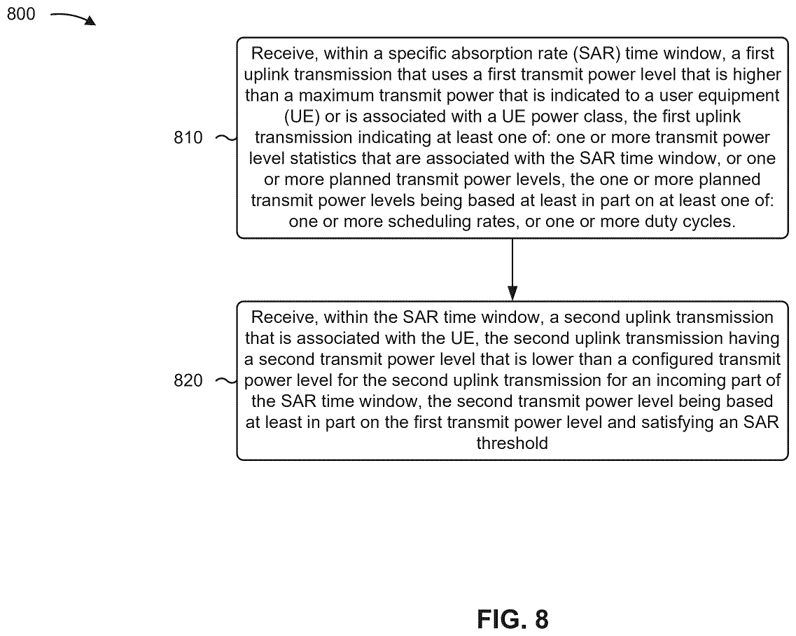

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with power level statistics and power level adjustments within an SAR time window, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

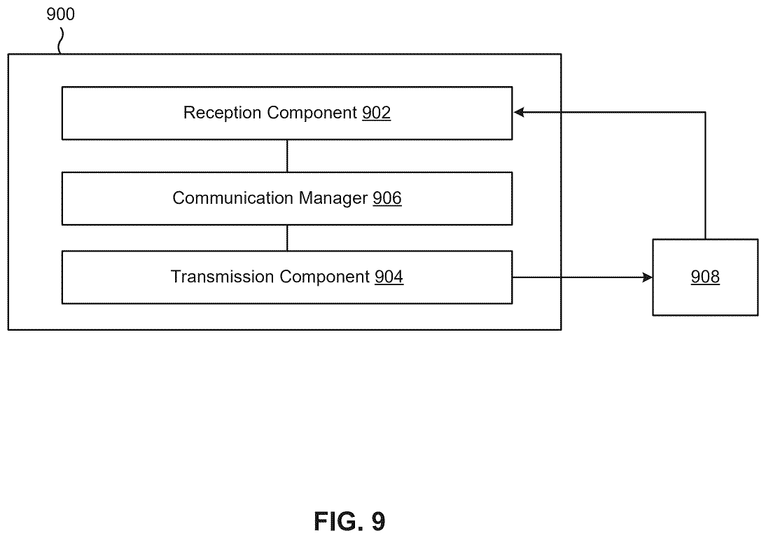

In some aspects, a UE (e.g., a UE 120) includes means for transmitting, within an SAR time window, a first uplink transmission using a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles; or means for transmitting, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

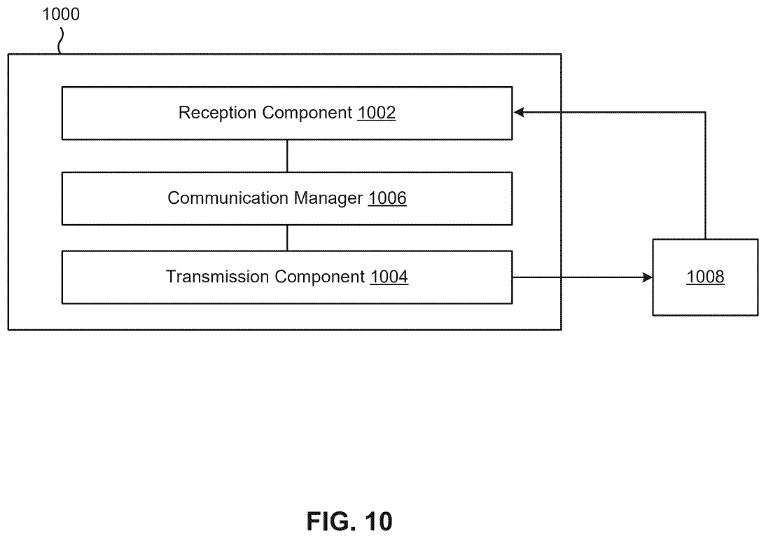

In some aspects, a network node (e.g., a network node 110) includes means for receiving, within an SAR time window, a first uplink transmission that uses a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles; or means for receiving, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

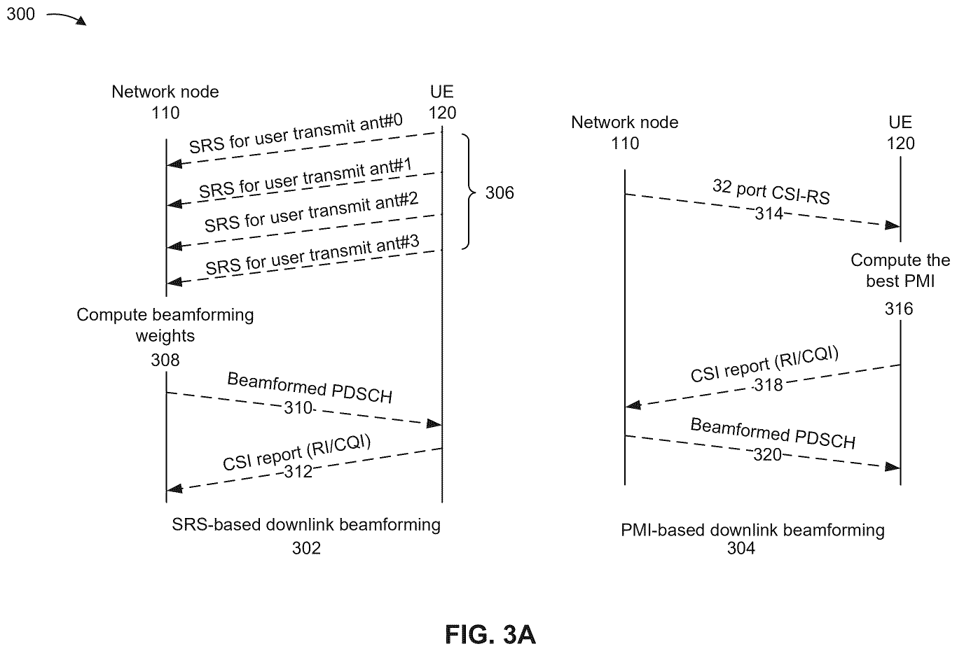

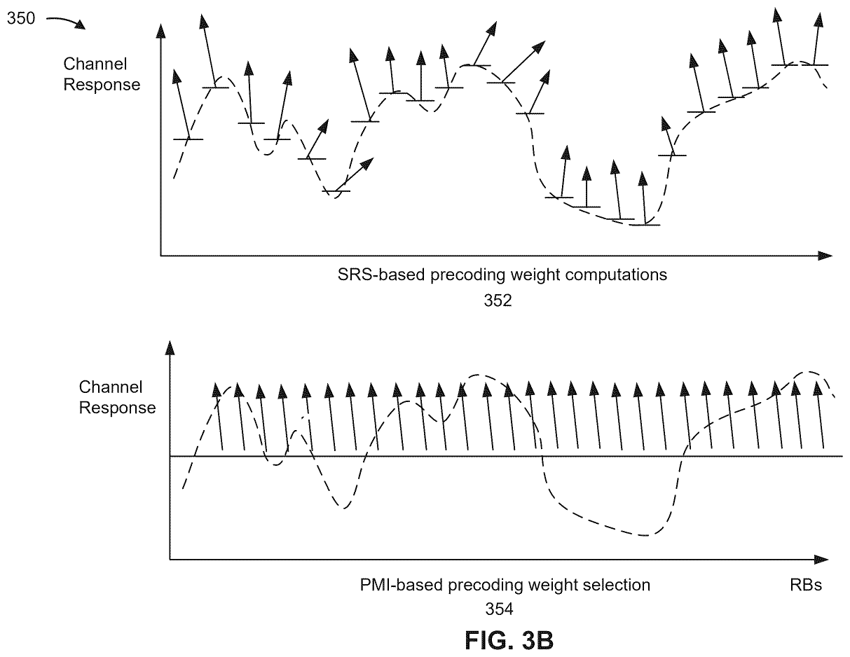

FIGS. 3A and 3B are diagrams illustrating a first example 300 of processes that may be used to select a downlink precoding matrix and a second example 350 of a comparison between the processes, respectively.

In a MIMO system, a transmitter and receiver may simultaneously communicate one or more data streams with one another using multiple antennas. As one example, the transmitter may use beamforming to simultaneously transmit a first data stream via a first beam and a second data stream via a second beam. To beamform the data streams via separate beams, the transmitter may apply a first set of precoding weights to a first signal associated with the first data stream such that antennas of an antenna array transmit respective weighted portions of the first signal that, when combined, form the first beam. Similarly, the transmitter may apply a second set of precoding weights to a second signal associated with the second data stream such that antennas of the antenna array transmit respective weighted portions of the second signal that, when combined, form the second beam. Each data stream and/or each signal may be referred to as a layer of a MIMO transmission. A number and/or quantity of spatial layers in a MIMO transmission may affect data rates and system performance. For instance, more spatial layers provide a MIMO transmission to carry more independent data streams, resulting in an increased overall throughput.

In some cases, the transmitter may apply the precoding weights using a precoding matrix that includes the precoding weights, and the precoding weights may be configured based at least in part on a particular operating configuration, such as an operating configuration that is based at least in part on any combination of a particular SNR, a particular receiver location, or particular interference. Alternatively, or additionally, the precoding weights may be based at least in part on a particular beam (e.g., a beam direction, a beam width, or a beam transmission angle). To increase a transmit signal quality (e.g., increase a transmit power level, reduce an interference level, increase data throughput, or any combination thereof), the transmitter may switch between different precoding weights (e.g., by switching between precoding matrices) using information about a current operating configuration.

The first example 300 shown by FIG. 3A includes a first signaling diagram 302 that describes a process for SRS-based downlink beamforming and a second signaling diagram 304 that describes a process for PMI-based downlink beamforming. In some cases, the processes described with regard to the first signaling diagram 302 and the second signaling diagram 304 may be based at least in part on TDD and channel reciprocity between an uplink channel and a downlink channel. For both the first signaling diagram 302 and the second signaling diagram 304, a transmitter (shown as a network node 110) selects precoding weights for transmitting a beamformed signal (e.g., a downlink beamformed signal) to a receiver (shown as a UE 120).

As shown by reference number 306 in the first signaling diagram 302, a UE 120 may transmit, and a network node 110 may receive, one or more SRSs using one or more antenna ports at the UE 120, and each antenna port may map to a respective combination of one or more antenna elements at the UE 120. To illustrate, the UE 120 transmits a first SRS using a first antenna port that is labeled as ant #0, a second SRS using a second antenna port that is labeled as ant #1, a third SRS using a third antenna port that is labeled as ant #2, and a fourth SRS using a fourth antenna port that is labeled as ant #3. In a simple example, each antenna port may map to a respective antenna element at the UE 120, and in a more complex example, each antenna port may map to unique combinations of the antenna elements at the UE 120. While FIG. 3A illustrates the UE 120 transmitting four SRSs via four antenna ports, other examples may include the UE 120 transmitting more SRSs or fewer SRSs via more antenna ports or fewer antenna ports. The UE 120 iteratively switching antenna ports for SRS transmission may alternatively be referred to as SRS antenna switching (AS).

As shown by reference number 308, the network node 110 may compute one or more precoding weights. To illustrate, the network node 110 may use the SRSs to compute a channel estimation of an uplink channel response that may be characterized using any combination of a channel gain (e.g., path loss or fading), a delay spread, or a phase response. In some cases, the network node 110 may use the SRSs to compute an uplink channel matrix that is a mathematical representation of the uplink channel response and, using channel reciprocity and an expectation that a downlink channel behaves in a comparable manner as the uplink channel, the network node 110 may compute precoding weights (or a precoding matrix) using the channel estimation. The network node 110 may compute optimal precoding weights (or precoding weights that are estimated to be optimal) to mitigate decoding errors that are due to a path loss, fading, or delay spread associated with the uplink channel response.

As shown by reference number 310, the network node 110 may transmit, and the UE 120 may receive, a transmission that is beamformed by the network node 110 using the computed precoding weights. As one example, the network node 110 may transmit a PDSCH transmission using beamforming, and the beamforming may be based at least in part on the computed precoding weights as described above.

As shown by reference number 312, the UE 120 may transmit, and the network node 110 may receive, a CSI report that indicates one or more measurement metrics. To illustrate, the UE 120 may compute one or more CSI measurement metrics as described above (e.g., CQI, RI, RSRP, RSSI, or RSRQ) using the PDSCH transmission, and may transmit the CSI measurement metric(s) in a CSI report that is directed to the network node 110. As one example, the network node 110 may include a DMRS in the PDSCH transmission, and the UE 120 may compute the CSI measurement metrics using the DMRS.

With regard to the second signaling diagram 304, as shown by reference number 314, the network node 110 may transmit, and the UE 120 may receive, a CSI-RS. While shown in FIG. 3A as being a 32 port CSI-RS (e.g., a CSI-RS that is transmitted via 32 antenna ports of the network node 110), other examples may include a CSI-RS that is transmitted by the network node 110 using more antenna ports or fewer antenna ports.

As shown by reference number 316, the UE 120 may compute or select a PMI (e.g., an optimal PMI for a downlink channel response) using the CSI-RS. For instance, in a similar manner as the network node 110 described with regard to the first signaling diagram 302, the UE 120 may compute a downlink channel estimation based at least in part on a downlink channel matrix that is a mathematical representation of the downlink channel response, and may use the downlink channel matrix to compute one or more measurement metrics that indicate any combination of a channel gain, a delay spread, or a phase response of the downlink channel response. The UE 120 may use the measurement metric(s) to select a precoding matrix, such as by selecting a precoding matrix from a codebook of predefined precoding matrices that mitigates recovery errors that are based at least in part on the path loss, the fading, or the delay spread. An example codebook may be a codebook of precoding weights that is specified by a communication standard, and the UE 120 may select particular precoding weights from the codebook that most closely match optimal precoding weights, relative to other precoding weights in the codebook.

As shown by reference number 318, the UE 120 may transmit, and the network node 110 may receive, a CSI report. The UE 120 may indicate, via the CSI report, any combination of CSI measurement metrics as described above, such as RI, CQI, PMI, RSRP, or any combination thereof.

As shown by reference number 320, the network node 110 may transmit, and the UE 120 may receive, a downlink transmission that is beamformed using the precoding weights selected and indicated by the UE 120 in the CSI report. An example downlink transmission may be a PDSCH transmission that is beamformed by the network node 110 using the precoding weights.

The second example 350 shown in FIG. 3B includes a first graph 352 and a second graph 354 that each compare a channel response (shown with a dotted line) to precoding weights (shown as vectors) for a transmission that propagates through a channel that is associated with the channel response. In each graph, the channel response and the precoding weights may each be represented as a complex value that includes a magnitude and a phase shift. In the first graph 352, the transmitter dynamically computes the precoding weights using an SRS-based channel estimation as described with regard to the first signaling diagram 302 shown in FIG. 3A, and, in the second graph 354, selects the precoding weights based at least in part on CSI feedback (e.g., a PMI) and a codebook as described with regard to the second signaling diagram 304 shown in FIG. 3A. Comparing the channel response to the precoding weights provides an indication of a precoding weight mismatch.

“Precoding weight mismatch” denotes a deviation from a first channel response, which is used to compute a set of precoding weights, and a second channel response through which a transmission that generated using the precoding weights propagates. That is, the precoding weights may be optimized for the first channel response, but may be used to generate a transmission that propagates through a channel that has a second channel response that deviates from the first channel response, and the deviation between the channel responses may result in precoding weights that are less effective at mitigating interference, directing a beam to a desired location, or a combination of the two. As shown by first graph 352, SRS-based precoding weight computations may be performed by a transmitter with a higher spatial and frequency domain granularity, relative to selecting precoding weights from a codebook as shown by the second graph 354. For example, the precoding weights shown by the first graph 352 vary from sub-band to sub-band, resulting in precoding weights with less mismatch across a frequency span relative to the precoding weights shown by the second graph 354. Thus, the SRS-based channel estimation process for computing or deriving precoding weights may increase an efficiency of the precoding weights (e.g., reduced interference, aligned beam direction, or a combination) relative to precoding weights selected using CSI feedback.

An uplink channel estimation computed by a network node 110 may be heavily influenced by a quality of an SRS received by the network node 110 or a quality of an SRS measurement generated by the network node 110. Examples of measurements may include SNR, RSRP, RSRQ, or an SINR. Alternatively, or additionally, the SRS quality, or a quality of the SRS measurement, may be based at least in part on properties of the SRS, such as a bandwidth, timing, or phase coherence. An SRS with low quality (e.g., a low SNR, a narrow bandwidth, or a large SRS timing error) may result in an inaccurate uplink channel estimation, and an SRS with high quality (e.g., a high SNR, a wide bandwidth, or a negligible SRS timing error) may result in an accurate uplink channel estimation. The accuracy or inaccuracy of an uplink channel estimation may lead to small or large amounts of precoding weight mismatches, respectively, and may impact a transmission quality, such as an amount of interference or an accuracy of a beam direction.

In some cases, a UE and a network node may use one or more SRSs to configure an uplink MIMO transmission, such as a codebook-based uplink MIMO transmission or a non-codebook-based uplink MIMO transmission. To illustrate, to configure a codebook-based uplink MIMO transmission, the UE may transmit one or more SRSs using one or more beams, and the network node may receive and analyze the SRS to select an uplink MIMO configuration (e.g., a rank, one or more SRS resources, and a codebook-based precoding configuration) for the UE. The network node may indicate the uplink MIMO configuration to the UE, and the UE may transmit an uplink MIMO transmission using the uplink MIMO configuration. Some uplink MIMO transmissions may include or carry one or more SRSs in the SRS resources indicated by the network node, such as through an SRS resource indicator (SRI). In some cases, the SRS resource(s) that are assigned to an uplink MIMO transmission may be SRS resources that are shared with SRS AS. In other cases, the SRS resource(s) that are assigned to the uplink MIMO transmission may be SRS resources that are separate from SRS resources that are assigned to SRS AS.

To configure a non-codebook-based uplink MIMO transmission, a network note may transmit a downlink reference signal, such as a CSI-RS, that the UE receives and analyzes. As an example, the UE may generate a downlink channel estimation, one or more measurement metrics, or a combination thereof, and analyze the downlink channel estimation (or the measurement metrics) to select potential precoding weights, potential beams, or a combination thereof. The UE may transmit one or more SRSs using the potential precoding weights and potential precoding beams that the network node receives and analyzes. For instance, in a similar manner as the UE, the network node may generate an uplink channel estimation, one or more measurement metrics, or a combination thereof, and may select one or more uplink beams that the network node determines are best suited for current channel conditions, such as by selecting the beam(s) with the highest RSRP values or the highest SNR values. The network node may transmit an indication of the selected uplink beam(s) to the UE, such as in a scheduling grant, and the UE may transmit an uplink MIMO transmission using the selected uplink beam(s). In either example, an accuracy of a channel estimation by the network node may be based at least in part on a quality of an SRS transmitted by the UE.

As indicated above, FIGS. 3A and 3B are provided as examples. Other examples may differ from what is described with regard to FIGS. 3A and 3B.

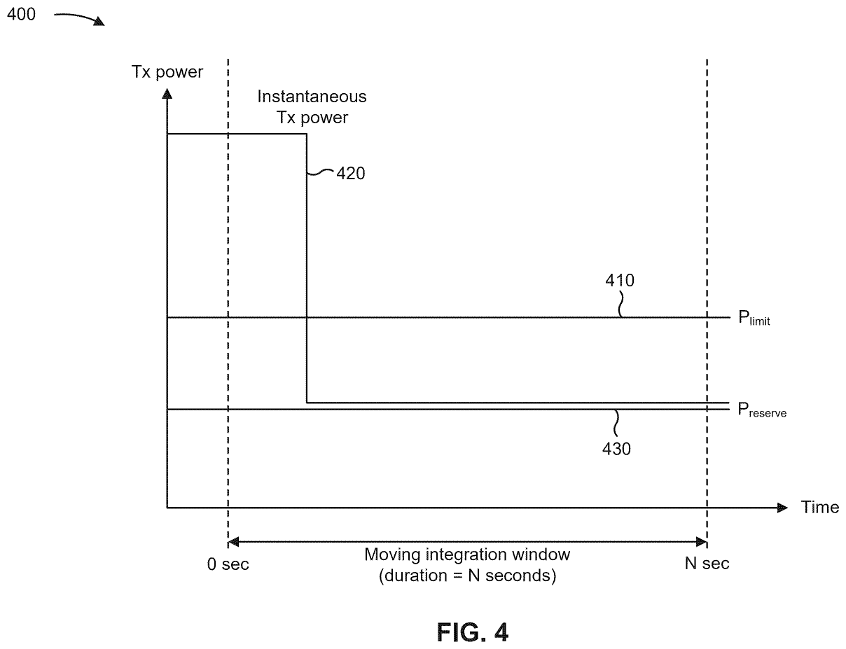

FIG. 4 is a diagram illustrating an example 400 of adapting a transmit power level over a moving integration window to satisfy one or more RF radiation exposure limits.

Because UEs may emit RF waves, microwaves, and/or other radiation, UEs are generally subject to regulatory RF safety requirements that set forth specific guidelines, or exposure limits, that constrain various operations that the UEs can perform. For example, RF emissions may generally increase when a UE is transmitting, and the RF emissions may further increase in cases where the UE is performing frequent transmissions, high-power transmissions, or the like. Accordingly, because frequent and/or high-power transmission may lead to significant RF emissions, regulatory agencies (e.g., the Federal Communications Commission (FCC) in the United States) may provide information related to acceptable RF radiation exposure when UEs are communicating using different radio access technologies.

In some examples, RF exposure may be expressed in terms of an SAR, which measures energy absorption by human tissue per unit mass and may have units of W/kg. For example, when a UE is communicating using a RAT that operates in a frequency range below 6 GHz, the applicable RF exposure parameter may include the SAR. In particular, SAR requirements generally specify that overall radiated power by a UE is to remain under a certain level to limit heating that may occur when RF energy is absorbed. Because SAR exposure may be used to assess RF exposure for transmission frequencies less than 6 GHz, SAR exposure limits typically cover wireless communication technologies such as 2G/3G (e.g., code division multiple access (CDMA)), 4G (e.g., 3GPP Long Term Evolution (LTE)), certain 5G bands (e.g., NR in 6 GHz bands), Institute of Electrical and Electronics Engineers (IEEE) 802.11ac, and other wireless communication technologies.

RF exposure may also be expressed in terms of power density (PD), which measures energy absorption per unit area and may be expressed in units of mW/cm². For example, when a UE is communicating using a RAT that operates in a high frequency range, such as a millimeter wave (mmW) frequency range, the applicable RF exposure parameter is PD, which may be regulated to limit heating of the UE and/or nearby surfaces. In certain cases, a maximum permissible exposure (MPE) limit in terms of PD may be imposed for wireless communication devices using transmission frequencies above 6 GHz. The MPE limit is a regulatory metric for exposure based on area, such as an energy density limit defined as a number, X, of watts per square meter (W/m²) averaged over a defined area and time-averaged over a frequency-dependent time window to prevent a human exposure hazard represented by a tissue temperature change. Because PD limits are typically used to assess RF exposure for transmission frequencies higher than 10 GHz, PD limits typically cover wireless communication technologies such as IEEE 802.11ad, 802.11ay, certain 5G bands (e.g., mmWave bands), and other wireless communication technologies. In some cases, SAR may reflect an impact of UE-generated electromagnetic energy on a human body, where a larger SAR value may indicate a greater impact, and a smaller SAR value may indicate a lesser impact. Given a same amount of transmit power, a smaller distance between a UE and a human body may lead to a larger SAR value. To illustrate, a UE under same conditions must reduce a transmit power level by a larger amount when in closer proximity to a human body to ensure safety for the human body.

Different metrics may be used to assess RF exposure for different wireless communication technologies. UEs generally must satisfy all applicable RF exposure limits (e.g., SAR exposure limits or PD (e.g., MPE) exposure limits), which are typically regulatory requirements that are defined in terms of aggregate exposure over a certain amount of time, and the aggregate exposure may be averaged over a moving integration window (or moving time window), sometimes referred to as a compliance window. For example, as shown in FIG. 4, and by reference number 410, a UE may be subject to an average power limit (Pₗᵢₘᵢₜ) that corresponds to an average power at which an SAR exposure limit and/or an MPE (e.g., PD) limit is satisfied if the UE were to transmit substantially continuously over a moving integration window of N seconds (e.g., 100 seconds), which may also be referred to as an SAR time window. Accordingly, as shown by reference number 420, the UE can use an instantaneous transmit power that exceeds the average power limit for a period of time provided that the average power over the moving integration window is under the average power limit at which the MPE limit is satisfied. For example, the UE may transmit at a maximum transmit power at the start of the moving integration window and then reduce the instantaneous transmit power until the moving integration window ends to ensure that the MPE limit on aggregate exposure is satisfied over the entire moving integration window. In general, as shown by reference number 430, the UE may reduce the instantaneous transmit power to a reserve power level (Pᵣₑₛₑᵣᵥₑ), which is a minimum transmit power level to maintain a link with a base station. “Incoming part” denotes a most recent transmission and, in turn an SAR power level measurement, within an SAR time window that is to validate compliance with an SAR operating condition.

A wireless communication device (e.g., UE 120) may simultaneously transmit signals using multiple wireless communication technologies. For example, the wireless communication device may simultaneously transmit signals using a first wireless communication technology operating at or below 6 GHz (e.g., 3G, 4G, sub-6 GHz frequency bands of 5G, etc.) and a second wireless communication technology operating above 6 GHz (e.g., mmWave bands of 5G in 24 to 60 GHz bands, IEEE 802.11ad or 802.11ay). In certain cases, the wireless communication device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHz bands, IEEE 802.11ad, 802.11ay, etc.) in which RF exposure is measured in terms of PD. By way of example, a UE may include multiple radios, modules, and/or antennas (referred to collectively herein simply as radios for convenience) corresponding to multiple RATs and/or frequency bands, which may be more readily understood with reference to FIG. 4. Since the UE is required to satisfy all applicable RF exposure parameters, the UE may be subject to both SAR and MPE limitations, or may be subject to different RF exposure parameters for different radios, modules, or antenna bands, as described elsewhere herein.

A UE satisfying an SAR operating condition (e.g., a regulatory requirement for transmission power levels) may result in decreased signal quality of an SRS transmitted by the UE (e.g., a reduced transmit power level, a reduced SNR, or a combination thereof), and received at a network node, resulting in less accurate channel estimations, less accurate measurement metrics, or a combination thereof. The less accurate channel estimations, or the less accurate measurement metrics, may lead to uplink scheduling or downlink scheduling with increased precoding weight mismatches, reduced signal quality, or a combination of the two, that leads to increased data recovery errors, reduced data throughput, or increased data transfer latencies. To mitigate decreased SRS quality, a UE may include support for SAR-compliant power level management, which may also be referred to as “smart transmission.” As at least part of SAR-compliant power level management, a UE may selectively increase a first transmit power level of a first uplink transmission above a first configured transmit power level for the first transmission, and may selectively reduce a second transmit power level of a second transmission below a second configured transmit power level for the second level in a manner that results in SAR compliance. The increase in the first transmit power level of the first transmission, the decrease in the second transmit power level of the second transmission, or a combination of the two, may be based at least in part on the first transmission and the second transmission occurring in a same SAR time window. To illustrate, the UE 120 may selectively increase a first transmit power level of a first transmission that is an SRS transmission as the first transmission within an SAR time window to increase an SRS quality received by the network node to increase an accuracy of an uplink channel estimation or measurement metrics. Other examples may include the UE 120 selectively increasing a transmit power level of a PUCCH that carries ACK/NACK feedback to ensure that the ACK/NACK feedback is decoded successfully. The UE may selectively reduce a second power level of a PUSCH transmission that occurs within the same SAR time window and is an incoming part of the SAR time window to ensure that an average transmit power level of the SRS transmission and the PUSCH transmission satisfy the SAR operating condition. Selectively increasing a transmit power level, or decreasing a transmit power level, may be based at least in part on a transmission type or information being carried by the transmission.

In some cases, a UE may autonomously perform SAR-compliant power level management without transmitting an indication to a network node, which may result in the network node generating an SRS measurement metric (e.g., an SRS SINR metric) using SRS with the increased power level. While the increased SRS power level may increase an accuracy of a channel estimation generated by the network node, the measurement metric generated using the SRS with the increased power level may also result in the network node scheduling a subsequent uplink transmission (e.g., a subsequent PUSCH transmission) using an aggressive scheduling configuration, and the aggressive scheduling configuration may result in recovery errors, reduced data throughput, or increased data transfer delays. For instance, based at least in part on the autonomously increased transmit power level (e.g., by the UE) being unknown to the network node, the network node may generate measurement metrics using the boosted SRS, and may schedule the subsequent uplink transmission with an increased MCS or an increased quantity of MIMO layers relative to scheduling the subsequent uplink transmission based at least in part on measurement metrics for an SRS that does not include the increased power level. In some cases, the subsequent uplink transmission may occur in a same SAR time window as the SRS with increased power level, and the UE may autonomously reduce, without notifying the network node, a transmit power level of the subsequent uplink transmission to maintain SAR compliance (e.g., without notifying the network node of the reduced transmit power level). The increased MCS, the increased quantity of MIMO layers, the reduced transmit power level of the subsequent uplink transmission (e.g., in the same SAR time window), or any combination thereof, may increase data recovery errors, decrease data throughput, increase a data transfer latency, or any combination thereof.

Various aspects relate generally power level statistics and power level adjustments within an SAR time window. Some aspects more specifically relate to a UE notifying a network node of transmit power level adjustments by the UE based at least in part on an SAR-compliant power level management capability of the UE. In some aspects, a UE may transmit, within an SAR time window, a first uplink transmission using a first transmit power level that is higher than a maximum transmit power that is indicated to a UE or is associated with a UE power class of the UE, such as a configured uplink power level or a transmit power level threshold that is specified for a UE power class (e.g., by a communication standard). Examples of a configured transmit power level may include any type of scheduling information or configuration information that is indicated to the UE in Layer 1 signaling (e.g., DCI), Layer 2 signaling (e.g., a MAC-CE), Layer 3 signaling (e.g., RRC signaling), or any combination thereof. Examples of uplink transmissions may include an SRS transmission, a PUCCH transmission, or a PUSCH transmission. In some aspects, the UE may indicate, in the first uplink transmission, at least one of: one or more transmit power level statistics that are associated with the SAR time window, or one or more planned transmit power levels that are based at least in part on at least one of: one or more scheduling rates, or one or more duty cycles. For instance, the UE may indicate a respective increased power level, a respective decreased power level, or any combination, for one or more uplink transmissions that occur within the SAR time window. Based at least in part on transmitting the first uplink transmission with an increased power level, the UE may transmit, within the SAR time window, a second uplink transmission using a second transmit power level that is based at least in part on the first transmit power level and satisfying an SAR threshold. For instance, the UE may reduce a power level of the second uplink transmission (e.g., relative to a configured transmit power level for the second uplink transmission) based at least in part on the second uplink transmission being an incoming part of the SAR time window to ensure SAR compliance. In some aspects, the UE may autonomously reduce the transmit power level of the second uplink transmission, and in other aspects, the UE may receive scheduling information that indicates a transmit power level for the second uplink transmission that is configured to satisfy the SAR threshold without autonomous power reduction by the UE.

In some aspects, a network node may receive, within an SAR time window, a first uplink transmission that uses a first transmit power level that is higher than a maximum transmit power that is indicated to a UE or is associated with a UE power class of the UE. The first uplink transmission may indicate at least one of: one or more transmit power level statistics that are associated with the SAR time window, or one or more planned transmit power levels, the one or more planned transmit power levels being based at least in part on at least one of: one or more scheduling rates, or one or more duty cycles. The network node may receive, within the SAR time window, a second uplink transmission that is associated with the UE, and the second uplink transmission may be based at least in part on a second transmit power level that is based at least in part on the first transmit power level and satisfying an SAR threshold. In some cases, prior to receiving the second uplink transmission, the network node may transmit scheduling information that indicates to use the second transmit power level for the second uplink transmission, where the second transmit power level is based at least in part on the first transmit power level and satisfying the SAR threshold. To illustrate, based at least in part on receiving the indication of the transmission power level statistics, the network node may select the second transmit power level, and instruct the UE to use the second power level.

Particular aspects of the subject matter described in this disclosure can be implemented to realize one or more of the following potential advantages. In some examples, by a UE indicating transmit power level statistics for an SAR window (e.g., transmit power level statistics that are based at least in part on an SAR-compliant power level management capability of the UE), the described techniques can be used to enable a network node to modify a transmit power level at the UE in a manner that maintains SAR compliance and mitigates a mismatch between the network node and the UE. More particularly, the indication of transmit power level statistics mitigates the network node selecting a scheduling configuration that results in recovery errors, such as the scheduling configuration with an increased MCS, increased quantity of MIMO layers, or a combination of the two, as described above. Alternatively, or additionally, the network node may select scheduling information for a subsequent uplink transmission within the SAR time window based at least in part on an expectation that the subsequent uplink transmission will have a reduced transmit power level to maintain SAR compliance. For instance, the network node may select, as at least part of the scheduling information, the reduced transmit power level, a MCS that is based at least in part on the reduced transmit power level, a quantity of MIMO layers that is based at least in part on the reduced transmit power level, or any combination thereof. In such a manner, the network node and the UE may mitigate recover errors, increase data throughput, and reduce data transfer latencies. For instance, the UE increasing a transmit power level of a PUCCH transmission may increase a probability that ACK/NACK notifications are recovered properly, resulting in an increased reliability of communications and increased resource usage efficiency. Alternatively, or additionally, the UE increasing a transmit power level of an SRS transmission may increase a quality or accuracy of an SRS-based measurement at the network node (e.g., an SRS SINR measurement), or a quality or accuracy of an uplink channel estimation, and may indicate to not use the increased transmit power level to schedule a subsequent uplink transmission. An increased accuracy of the uplink channel estimation may reduce precoding weight mismatch at the network node and increase SRS-based downlink MIMO performance (e.g., reduced recovery errors, increased data throughput, or reduced data transfer latencies). Alternatively, or additionally, indicating to not use the increased transmit power level to schedule a subsequent uplink transmission may also mitigate the network node selecting an aggressive scheduling configuration, resulting in reduced recovery errors, increased data throughput, and reduced data transfer latencies.

An SAR-compliant power level management capability at a UE enables the UE to transmit system-impacting uplink signals, such as an SRS or a PUCCH (e.g., carrying ACK/NACK feedback), by selectively using a higher transmit power level to increase a signal quality of the system-impacting uplink signals, resulting in an accuracy of an uplink channel estimation by the network node (e.g., for an SRS) or reduced recovery errors (e.g., for a PUCCH). As an example of selectively using a higher transmit power level, the UE may boost the transmit power level of a system-impacting uplink signal, and may not boost the transmit power level of other uplink signals that have less impact on the system. The UE utilizing the SAR-compliant power level management capability may also enable the UE (or the network node by way of the indicated transmit power level statistics and scheduling information) to reduce a transmit power level for a subsequent uplink transmission within a same SAR time window as the system-impacting uplink signal with an increased transit power level to satisfy an SAR operating condition.

The indication of the transmit power level statistics also enables the network node to compensate for an expected power reduction in an uplink transmission and reduce recovery errors for uplink data. Alternatively, or additionally, the transmit power level statistics may also enable the network node to select a scheduling configuration for the UE that results in more efficient power level management, more accurate compensation for channel impairments or signal degradation due to propagation through a wireless channel, or a combination of the two. To illustrate, a UE may transmit a scheduling request to a network node for an uplink grant, but may have little to no control over, or visibility into, any combination of when the network node may transmit the uplink grant, an actual configuration of the uplink grant, an uplink scheduling rate, or a duty cycle, which may impact how the UE uses SAR-compliant power level management. Alternatively, or additionally, the network node may have information unavailable to the UE, such as uplink channel conditions (e.g., via an uplink channel estimation), a current network load, load balancing in the network, or any combination thereof, that enables the network node to manage a balance of increased transmit power levels and decreased transmit power levels in a more efficient manner than the UE. For instance, the network node may schedule the second uplink transmission with a higher transmit power level (e.g., relative to autonomous selection by the UE) based at least in part on using a reduced scheduling rate, or may schedule the second uplink transmission with a lower transmit power level (e.g., relative to autonomous selection by the UE) based at least in part on using an increased scheduling rate. In some cases, the network node can use a scheduling configuration to compensate for channel impairments (e.g., impairments indicated by an SINR metric), such as through an MCS configuration or a MIMO layer configuration, resulting in reduced recovery errors, increased data throughput, and reduced data transfer latencies.

As indicated above, FIG. 4 is provided as an example. Other examples may differ from what is described with regard to FIG. 4.

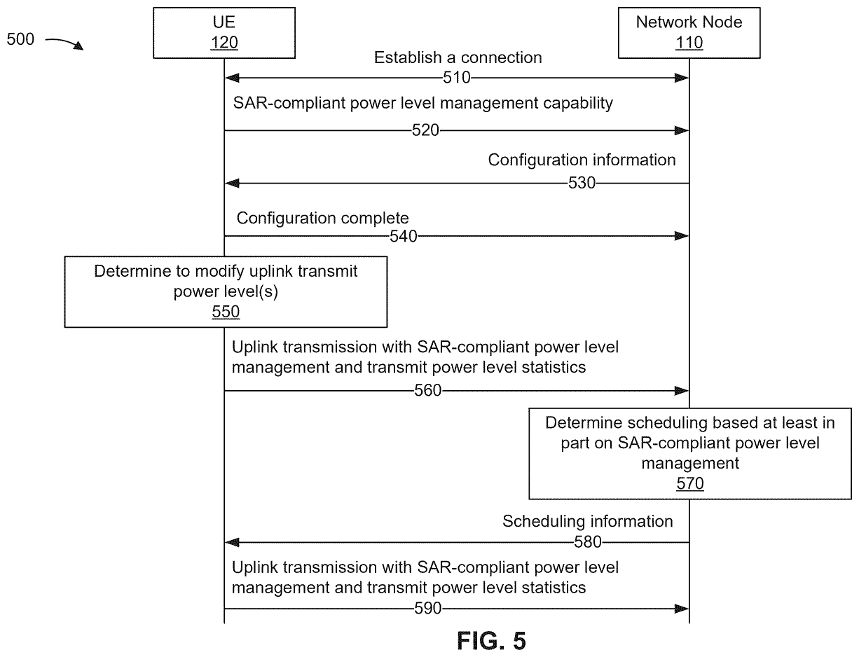

FIG. 5 is a diagram illustrating an example 500 of a wireless communication process between a network node (e.g., the network node 110) and a UE (e.g., the UE 120).

As shown by reference number 510, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., DCI and/or UCI), Layer 2 signaling (e.g., a MAC-CE), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC-CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays.

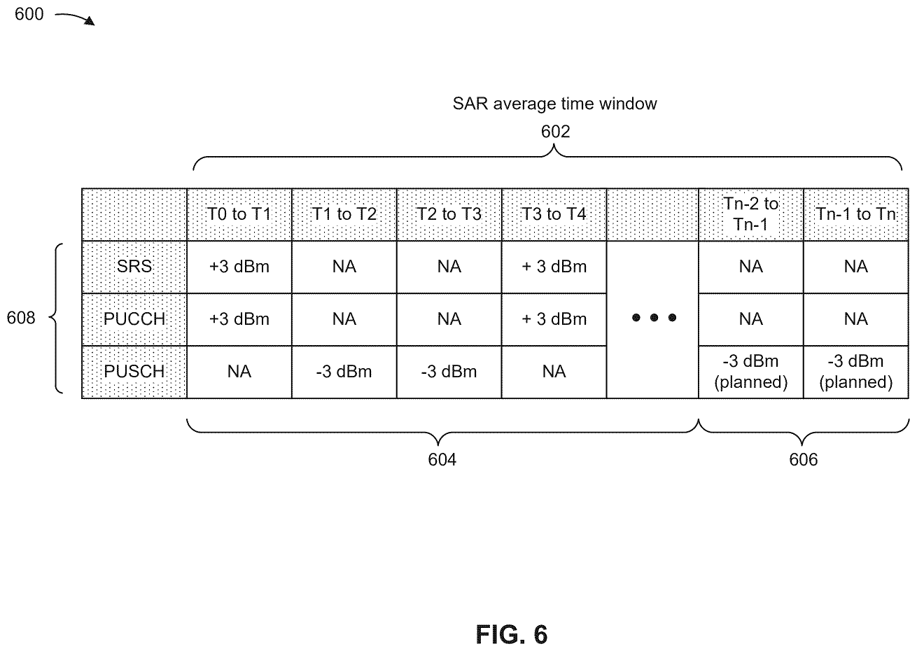

As shown by reference number 520, the UE 120 may transmit, and the network node 110 may receive, an indication of support for SAR-compliant power level management. For instance, the UE 120 may indicate support for modifying transmit power levels of one or more uplink transmissions, such as by increasing a first transmit power level of a first uplink transmission (e.g., a system-impacting uplink transmission, such as an SRS, an SRS AS, a PUCCH, or a PUSCH), decreasing a second transmit power level of a second uplink transmission (e.g., a PUSCH) to satisfy an SAR operating condition, or a combination of the two. As described above, the SAR-compliant power level management may alternatively be referred to as “smart transmission.” As at least part of SAR-compliant power level management, a UE may increase a transmit power level above a maximum transmit power as specified for a UE power class, a configured transmit power level (e.g., configured using any combination of Layer 1 signaling, Layer 2 signaling, or Layer 3 signaling), or a combination thereof. In indicating support for SAR-compliant power level management, the UE 120 may indicate a transmit power level increase that is supported by the UE 120, such as by indicating that the UE 120 supports a transmit power level increase of X decibels (dB) above a maximum transmit power that is specified for a UE power class of the UE 120 (X being a variable number). Alternatively, or additionally, the UE 120 may indicate a supported transmission type for a transmit power level increase, such as by indicating that the UE 120 includes a capability to apply a transmit power increase to any combination of one or more of an SRS transmission (e.g., an SRS AS, an UL MIMO SRS, or a combination of the two), a PUCCH transmission (e.g., a PUCCH transmission carrying ACK/NACK), or a PUSCH transmission. In some aspects, the UE 120 may indicate a supported transmission type for a transmit power level decrease (e.g., below a configured transmit power level), such as by indicating support for decreasing a transmit power level for a PUSCH transmission. As at least part of indicating support for SAR-compliant power level management, the UE 120 may indicate support for transmitting an indication of one or more transmit power level statistics as described below with regard to FIG. 6.

For clarity, FIG. 5 illustrates the UE 120 transmitting the indication of the SAR-compliant power level management capability in a separate transaction than establishing a connection with the network node 110 in the example 500. However, in some aspects, the UE 120 may transmit the indication of the SAR-compliant power level management capability as part of establishing a connection with the network node 110.

As shown by reference number 530, the network node 110 may transmit, and the UE 120 may receive, configuration information. In some aspects, the configuration information may include one or more configuration parameters for SAR-compliant power level management at the UE 120. As one example, the network node 110 may transmit at least some configuration information as at least part of an RRC reconfiguration message.

As one example, the network node 110 may indicate a configuration parameter that enables or disables SAR-complaint power level management at the UE 120. As another example, the network node 110 may indicate a configuration parameter that specifies one or more eligible (or ineligible) transmission types for SAR-compliant power level management, such as by indicating that both SRS AS and UL MIMO SRS are eligible in a first scenario in which SRS AS and UL MIMO SRS share SRS resources, or that SRS AS is eligible and UL MIMO SRS is ineligible in a second scenario in which SRS AS and UL MIMO SRS use different SRS resources. Alternatively, or additionally, the network node 110 may indicate one or more trigger conditions for applying SAR-compliant power level management, such as by indicating a measurement metric threshold and to enable SAR-compliant power level management based at least in part on a measurement metric satisfying the measurement metric threshold. As described above, SAR-compliant power level management may be based at least in part on satisfying an SAR operating condition as specified by an SAR threshold, where the increase in transmit power level and the decrease in transmit power level may be based at least in part on a configured transmit power level for one or more uplink transmissions by the UE 120.

In some aspects, the configuration information may indicate a transmit power level increase to apply, a transmit power level decrease to apply, or a combination of the two, as at least part of SAR-compliant power level management. For instance, the network node 110 may transmit configuration information that instructs the UE to transmit periodic SRS, aperiodic SRS, or a PUCCH using an X dB increase above a maximum transmit power that is configured for the periodic SRS, the aperiodic SRS, or the PUCCH. Applying the configuration information may be conditional on the UE 120 detecting a trigger event. The configuration information may be transmitted by the network node 110 in multiple transmissions, such as by transmitting a first portion of the configuration information that indicates a configured transmit power level or a maximum power level threshold for an uplink transmission (e.g., an SRS or PUCCH) in an RRC reconfiguration message, and a second portion of the configuration information in Layer 1 signaling (e.g., DCI) that indicates to apply the X dB increase over the maximum transmit power as at least part of the SAR-compliant power level management.

While the network node 110 may indicate configuration information for SAR-compliant power level management, other examples may include a communication standard specifying configuration information such that the SAR-compliant power level management configuration is implicit based at least in part on the network node 110 indicating an enabled state for the SAR-compliant power level management.

As shown by reference number 540, the UE 120 may transmit, and the network node 110 may receive, a configuration complete message. For example, the UE 120 may transmit an RRC reconfiguration complete message based at least in part on the network node 110 transmitting an RRC reconfiguration message. In transmitting the configuration complete message, the UE 120 may indicate that the configuration information transmitted by the network node 110 as described with regard to reference number 530 has been received and applied by the UE 120. For instance, the UE 120 may indicate that SAR-compliant power level management is enabled, or that SAR-compliant power level management is conditionally enabled based at least in part on a trigger event.

As shown by reference number 550, the UE 120 may determine to modify one or more uplink transmit power levels. That is, the UE 120 may determine to use SAR-compliant power level management. As one example, the UE 120 may identify a first trigger condition for increasing a first transmit power level of a first uplink transmission (e.g., an SRS, a PUCCH, or a PUSCH), a second trigger condition for reducing a second transmit power level of a second uplink transmission (e.g., a PUSCH), or a third trigger condition that is a combination of the first trigger condition and the second trigger condition. In some aspects, the UE 120 may determine to use SAR-compliant power level management based at least in part on computing that an uplink transmission may only satisfy an SAR operating condition (e.g., an SAR threshold) based at least in part on transmit power level reduction.

To illustrate, the UE 120 may identify a trigger condition to increase the transmit power level of a first uplink transmission based at least in part on a transmission type of the uplink transmission (e.g., an SRS or PUCCH with ACK/NACK), based at least in part on an SNR level satisfying a trigger threshold, or a combination of the two. Based at least in part on increasing the transmit power level of the first uplink transmission, the UE 120 may reduce a transmit power level of a second uplink transmission (e.g., a PUSCH) that occurs within a same SAR time window as the first uplink transmission and is an incoming part to the SAR time window in order to satisfy an SAR operating condition. As another example, the UE 120 may identify a trigger condition to reduce the transmit power level of a PUSCH transmission in an SAR time window, and may increase the transmit power level of an SRS transmission that is within the SAR time window and is an incoming part of the SAR time window to increase a signal quality of the SRS transmission.

As shown by reference number 560, the UE 120 may transmit, and the network node 110 may receive, an uplink transmission, and the uplink transmission may have a modified transmit power level that is based at least in part on SAR-compliant power level management. For instance, the uplink transmission may be an SRS transmission or a PUCCH transmission that includes an increased transmit power level, and the UE 120 may transmit the uplink transmission with the modified transmit power level (e.g., modified relative to a configured transmit power level, a configured maximum power level threshold, a maximum power level relative to a UE power class of the UE, or any combination hereof). The UE 120 may autonomously select an amount of increase in the transmit power level, or may use an amount of increase indicated by the network node 110 (e.g., X dB). In some aspects, the uplink transmission may be a first uplink transmission in an SAR time window.

In some aspects, the uplink transmission carries one or more transmit power level statistics, such as the transmit power level statistics described with regard to FIG. 6. Example transmit power level statistics may include any combination of an amount of increase in a transmit power level, an amount of decrease in a transmit power level, a time resource associated with the increase or decrease in the transmit power level, or a transmission type. In some aspects, the uplink transmission may carry the transmit power level statistic(s) in Layer 2 signaling (e.g., a MAC-CE).

Alternatively, or additionally, the uplink transmission may carry one or more planned one or more transmit power levels (e.g., for one or more future uplink transmissions), which may alternatively be referred to as UE-preferred transmit power levels. In some cases, the one or more planned transmit power levels may be based at least in part on one or more potential future scheduling rates (e.g., an uplink scheduling rate for the UE within a SAR time window), one or more potential future duty cycles (e.g., a duty cycle of scheduling for the UE within the SAR time window), or a combination of the two. To illustrate, the UE 120 may compute a first planned transmit power level (or a first UE-preferred transmit power level) for one or more subsequent uplink transmissions in the SAR time window that may be based at least in part on a first potential future scheduling rate or a first potential future duty cycle, and a second planned transmit power level (or a second UE-preferred transmit power level) for one or more subsequent uplink transmissions in the SAR time window that use a second potential future scheduling rate or a second potential future duty cycle. For instance, the UE 120 may compute a lower planned transmit power level for one or more future uplink transmissions in the SAR window that have a higher scheduling rate, and a higher transmit power level for one or more future uplink transmissions in the SAR window that have a lower scheduling rate, to satisfy a SAR operating condition. The UE 120 may indicate the planned transmit power level(s) to account for various potential future scheduling rates or various potential future duty cycles that may be used by the network node (and are unknown to the UE 120) to schedule the UE 120 for the future uplink transmission(s). The UE 120 may transmit an indication of the planned transmit power level(s) in a same MAC-CE as tone or more transmit power level statistic, or may transmit the indication of the planned transmit power level(s) in a different MAC-CE (e.g., that is part of the first uplink transmission).

While the example 500 includes the UE 120 transmitting an uplink transmission that includes an indication of one or more transmit power level statistics, one or more planned transmit power levels, or any combination thereof, other examples may include the UE 120 transmitting a power headroom report that indicates one or more planned power headrooms (e.g., a Power level 2 power headroom) that are based at least in part on one or more scheduling rates, one or more duty cycles, or a combination of the two. For instance, the UE 120 may compute a planned power headroom that is based at least in part on a planned transmit power level as described above. The planned transmit power level and the planned power headroom may be based at least in part on a potential future scheduling rate or a potential future duty cycle in uplink scheduling that is assigned to the UE. As one example, the UE 120 may compute the planned power headroom as a maximum transmit power level—a planned transmit power level.

As shown by reference number 570, the network node 110 may determine a scheduling configuration for the UE 120 based at least in part on the transmit power level statistics indicated in the uplink transmission described with regard to reference number 560. As one example, the network node 110 may generate an uplink measurement metric using the uplink transmission, such as an uplink SINR measurement, using an SRS that is included in the uplink transmission. Based at least in part on the uplink transmission carrying the power level statistics (e.g., in a MAC-CE as described above), the network node 110 may adjust the computed uplink measurement metric to compensate for a power level adjustment performed by the UE 120, such as by compensating for the UE increasing in the transmit power level based at least in part on SAR-compliant power level management. The network node 110 may use the adjusted uplink measurement metric to determine a scheduling configuration. For example, the network node 110 may use an adjusted uplink SINR measurement metric to select a scheduling configuration for a subsequent uplink transmission (e.g., a PUSCH) by the UE 120 that is within a same SAR time window (e.g., as an incoming part of the SAR time window). To illustrate, the network node 110 may select, as at least part of the scheduling configuration, an MCS configuration, a MIMO layer configuration, a transmit power level, or any combination thereof, using the adjusted uplink measurement metric. In some cases, the network node 110 may indicate to use, as a configured transmit power level, a reduced transmit power level based at least in part on an SAR operating condition and the second uplink transmission being an incoming part of the SAR time window that is associated with the first uplink transmission. The network node 110 may compute the reduced transmit power level based at least in part on information at the network node 110, such as a scheduling rate (e.g., a quantity of uplink transmissions to be scheduled for the UE 120 within the SAR time window), a network load, or load balancing. Alternatively, or additionally, the network node 110 may compute the reduced transmit power level based at least in part on a transmit power level of the uplink transmission and an SAR time window of the UE 120. As yet another example, the network node 110 may compute the reduced transmit power level using the transmit power level statistics to compute a reduced transmit power level that complies with an SAR operating condition. In some aspects, the network node 110 may select other transmission parameters, such as an MCS or a MIMO layer count, based at least in part on the reduced transmit power level. To illustrate, the subsequent uplink transmission channel may be a PUSCH transmission and, based at least in part on the reduced transmit power level, the network node 110 may configure fewer MIMO layers or a lower MCS for the PUSCH transmission relative to a MIMO layer count or an MCS for a PUSCH transmission that does not use the reduced transmit power level.

As shown by reference number 580, the network node 110 may transmit, and the UE 120 may receive, scheduling information. In some aspects, the scheduling information may indicate the scheduling configuration that is based at least in part on any combination of the transmit power level statistics, the transmit power level of the uplink transmission described with regard to reference number 560, or information at the network node as described with regard to reference number 570. In one example, the network node 110 may transmit the scheduling information in DCI for an uplink grant, and the scheduling information may indicate to reduce a transmit power level for the pending uplink transmission based at least in part on SAR-compliant power level management, or may indicate a reduced transmit power level.

While the example 500 includes the network node 110 transmitting scheduling information that may be based at least in part on the transmit power level statistics, other examples may not include the network node 110 transmitting scheduling information that is based at least in part on the transmit power level statistics.

As shown by reference number 590, the UE 120 may transmit, and the network node 110 may receive, an uplink transmission. The uplink transmission may be at least a second uplink transmission in an SAR time window as the first uplink transmission described with regard to reference number 560. Alternatively, or additionally, the uplink transmission may be an incoming part of the SAR time window. The UE 120 may transmit the uplink transmission with a reduced transmit power level based at least in part on SAR-compliant power level management, scheduling information from the network node, or a combination of the two.

Based at least in part on the SAR time window being a moving time average, the UE 120 may increase a transmit power level of a third uplink transmission that is an incoming part of the SAR time window (e.g., that no longer includes the first uplink transmission but includes the second uplink transmission) to increase a signal quality. For instance, the third uplink transmission may be an SRS AS, and the UE 120 may increase the transmit power level of the SRS AS.

An SAR-compliant power level management capability at a UE enables the UE to transmit system-impacting uplink signals, such as an SRS or a PUCCH, by selectively using a higher transmit power level to increase a signal quality of the system-impacting uplink signals, resulting in an accuracy of an uplink channel estimation by the network node or reduced recovery errors. The UE utilizing the SAR-compliant power level management capability may also enable the UE (or the network node by way of the indicated transmit power level statistics and scheduling information) to reduce a transmit power level for a subsequent uplink transmission within a same SAR time window as the system-impacting uplink signal with an increased transit power level to satisfy an SAR operating condition.

The indication of the transmit power level statistics also enables the network node to compensate for an expected power reduction in an uplink transmission and reduce recovery errors for uplink data. Alternatively, or additionally, the transmit power level statistics may also enable the network node to select a scheduling configuration for the UE that results in more efficient power level management, more accurate compensation for channel impairments or signal degradation due to propagation through a wireless channel, or a combination of the two. In some cases, the network node can use a scheduling configuration to compensate for channel impairments (e.g., impairments indicated by an SINR metric), such as through an MCS configuration or a MIMO layer configuration, resulting in reduced recovery errors, increased data throughput, and reduced data transfer latencies.

As indicated above, FIG. 5 is provided as an example. Other examples may differ from what is described with regard to FIG. 5.

FIG. 6 is a diagram illustrating a table 600 of example transmit power level statistics.

The table 600 shown in FIG. 6 includes multiple columns that each map to a respective time partition (e.g., a slot, a mini-slot, a transmission time interval, or a subframe) within an SAR average time window 602. For instance, a first column maps to a first time partition labeled as “T0 to T1” and a second column maps to a second time partition labeled as “T1 to T2”. At least a portion of the multiple columns may map to one or more past time partitions 604 within the SAR average time window 602. Alternatively, or additionally, at least some of the multiple columns may map to one or more future time partitions 606 within the SAR average time window. The table 600 also includes multiple rows 608, and each row may map to a respective uplink transmission that occurs within a time partition. For instance, as shown by FIG. 6, the table 600 includes a first row that is associated with an SRS transmission, a second row that is associated with a PUCCH, and a third row that is associated with a PUSCH. In some aspects, a UE (e.g., a UE 120) may transmit an indication of information that is included in the table 600, such as in any combination of Layer 1 signaling, Layer 2 signaling, or Layer 3 signaling, to indicate SAR-compliant power level adjustments that were applied by the UE, are planned by the UE, or any combination thereof.

As an example, each entry in the table 600 that is located within the past time partition(s) 604 indicates a power level adjustment (e.g., an increase or a decrease) that was applied by the UE to a respective uplink transmission within the associated time partition. In the first time partition (e.g., T0 to T1), the UE applied a first power increase to a first uplink transmission (shown as a 3 decibel milliwatts (dBm) increase that is applied to an SRS) and a second power increase to a second uplink transmission (shown as a 3 dBm increase that is applied to a PUCCH). A third uplink transmission (shown as PUSCH) may carry a null value to indicate that no power level changes were applied, or that a third uplink transmision was not transmitted. In the second time partition (e.g., T1 to T2), the table 600 indicates that a power level decrease (shown as −3 dBm) was applied by the UE to the third uplink transmission (e.g., a PUSCH transmission). Accordingly, entries within the time partitions and uplink transmissions that are located within the past time partition(s) 604 indicate what power level adjustments were applied by the UE.

Alternatively, or additionally, each entry in the table 600 that is located within the future time partitions(s) 606 indicates a power level adjustment (e.g., an increase or a decrease) that is planned by the UE for a respective uplink transmission within the associated future time partition. For instance, in the first future time partition (e.g., Tn-2 to Tn-1), the UE plans to apply a power level decrease (shown as −3 dBm) to a third uplink transmission (e.g., a PUSCH transmission). Similarly, in the second future time partition (e.g., Tn-1 to Tn), the UE plans to apply a power level decrease (shown as −3 dBm) to a third uplink transmission (e.g., a PUSCH transmission) occurring with the associated future time partition. Accordingly, entries within the time partitions and uplink transmissions that are located within the future time partition(s) 606 indicate what power level adjustments were applied by the UE. In some aspects, the future time partition(s) 606 may indicate one or more planned transmit power levels that are based at least in part on one or more scheduling rates, one or more duty cycles, or any combination as described above.

As indicated above, FIG. 6 is provided as an example. Other examples may differ from what is described with regard to FIG. 6.

FIG. 7 is a diagram illustrating an example process 700 performed, for example, at a UE or an apparatus of a UE. Example process 700 is an example where the apparatus or the UE (e.g., UE 120) performs operations associated with power level statistics and power level adjustments within an SAR time window.

As shown in FIG. 7, in some aspects, process 700 may include transmitting, within an SAR time window, a first uplink transmission using a first transmit power level that is higher than a maximum transmit power that is indicated to a UE or is associated with a UE power class of the UE, or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles (block 710). For example, the UE (e.g., using transmission component 904 or communication manager 906, depicted in FIG. 9) may transmit, within an SAR time window, a first uplink transmission using a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles, as described above.

As further shown in FIG. 7, in some aspects, process 700 may include transmitting, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold (block 720). For example, the UE (e.g., using transmission component 904 or communication manager 906, depicted in FIG. 9) may transmit, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold, as described above.

Process 700 may include additional aspects, such as any single aspect or any combination of aspects described below or in connection with one or more other processes described elsewhere herein.

In a first aspect, the first uplink transmission includes at least one of a sounding reference signal, or a physical uplink control channel.

In a second aspect, process 700 includes receiving scheduling information for the second uplink transmission, the scheduling information indicating to use the second transmit power level.

In a third aspect, the first uplink transmission carries an indication of at least one of: the one or more transmit power level statistics, or the one or more planned power headrooms, in one or more MAC-CEs.

In a fourth aspect, process 700 includes transmitting an indication of support for SAR-compliant power level management, and receiving configuration information that indicates to enable the SAR-compliant power level management.

In a fifth aspect, the support for the SAR-compliant power level management includes an ability to transmit at a higher power level relative to the maximum transmit power that is specified for the UE power class that is assigned to the UE.

In a sixth aspect, the configuration information indicates to enable the SAR-compliant power level management for at least one of a sounding reference signal, or a physical uplink control channel.

In a seventh aspect, the configuration information includes SRS configuration information, the SRS configuration information indicates a first SRS resource for SRS AS and a second SRS resource for uplink MIMO SRS, and the configuration information indicates to enable the SAR-compliant power level management for the SRS AS and not for the uplink MIMO SRS.

In an eighth aspect, the configuration information includes SRS configuration information, the SRS configuration information indicates a shared SRS resource for SRS AS and uplink MIMO SRS, and the configuration information indicates to enable the SAR-compliant power level management for the SRS AS and for the uplink MIMO SRS.

In a ninth aspect, transmitting the second uplink transmission using the second transmit power level includes using a lower power level than a configured power level and without receiving scheduling information that indicates to use the second transmit power level.

In a tenth aspect, process 700 may include transmitting a power headroom report that indicates one or more planned power headrooms that are based at least in part on at least one of: one or more scheduling rates, or one or more duty cycles.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with power level statistics and power level adjustments within an SAR time window.

As shown in FIG. 8, in some aspects, process 800 may include receiving, within an SAR time window, a first uplink transmission that uses a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles (block 810). For example, the network node (e.g., using reception component 1002 or communication manager 1006, depicted in FIG. 10) may receive, within an SAR time window, a first uplink transmission that uses a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles, as described above. In some cases, the maximum transmit power may be configured for the first uplink transmission.

As further shown in FIG. 8, in some aspects, process 800 may include receiving, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold (block 820). For example, the network node (e.g., using reception component 1002 or communication manager 1006, depicted in FIG. 10) may receive, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold, as described above.

Process 800 may include additional aspects, such as any single aspect or any combination of aspects described below or in connection with one or more other processes described elsewhere herein.

In a first aspect, the first uplink transmission includes at least one of a sounding reference signal, or a physical uplink control channel.

In a second aspect, process 800 includes transmitting, based at least in part on receiving the transmit power level statistics, scheduling information for the second uplink transmission, and the scheduling information indicates to use the second transmit power level.

In a third aspect, the first uplink transmission carries an indication of the one or more transmit power level statistics in a MAC-CE.

In a fourth aspect, process 800 includes receiving an indication of support for SAR-compliant power level management, and transmitting configuration information that indicates to enable the SAR-compliant power level management.

In a fifth aspect, the support for the SAR-compliant power level management includes an ability to transmit at a higher power level relative to the maximum transmit power that is specified for the UE power class that is assigned to the UE.

In a sixth aspect, the configuration information indicates to enable the SAR-compliant power level management for at least one of a sounding reference signal, or a physical uplink control channel.

In a seventh aspect, the configuration information includes SRS configuration information, the SRS configuration information indicates a first SRS resource for SRS AS and a second SRS resource for uplink MIMO SRS, and the configuration information indicates to enable the SAR-compliant power level management for the SRS AS and not for the uplink MIMO SRS.

In an eighth aspect, the configuration information includes SRS configuration information, the SRS configuration information indicates a shared SRS resource for SRS AS and uplink MIMO SRS, and the configuration information indicates to enable the SAR-compliant power level management for the SRS AS and for the uplink MIMO SRS.

In a ninth aspect, receiving the second uplink transmission using the second transmit power level includes receiving the second uplink transmission that uses the second transmit power level without transmitting scheduling information that indicates to use the second transmit power level.

In a tenth aspect, process 800 includes computing an uplink measurement metric based at least in part on the first uplink transmission, computing an adjusted uplink measurement metric based at least in part on the one or more transmit power level statistics, and selecting a scheduling configuration for the second uplink transmission based at least in part on the adjusted uplink measurement metric.

In an eleventh aspect, selecting the scheduling configuration for the second uplink transmission includes selecting a configured transmit power level based at last in part on at least one of: a scheduling rate, or the SAR threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, within an SAR time window, a first uplink transmission using a first transmit power level that is higher than a maximum transmit power that is indicated to a UE or is associated with a UE power class of the UE, the first uplink transmission indicating one or more transmit power level statistics that are associated with the SAR time window. The transmission component 904 may transmit, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

The reception component 902 may receive scheduling information for the second uplink transmission, the scheduling information indicating to use the second transmit power level. In some aspects, the transmission component 904 may transmit an indication of support for SAR-compliant power level management. Alternatively, or additionally, the reception component 902 may receive configuration information that indicates to enable the SAR-compliant power level management.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive, within an SAR time window, a first uplink transmission that uses a first transmit power level that is higher than a maximum transmit power that is indicated to a UE (e.g., a maximum transmit power that is configured for the first uplink transmission) or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles. The reception component 1002 may receive, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold.

The transmission component 1004 may transmit, based at least in part on receiving the transmit power level statistics, scheduling information for the second uplink transmission, and the scheduling information indicates to use the second transmit power level. In some aspects, the reception component 1002 may receive an indication of support for SAR-compliant power level management. Alternatively, or additionally, the transmission component 1004 may transmit configuration information that indicates to enable the SAR-compliant power level management.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: transmitting, within a specific absorption rate (SAR) time window, a first uplink transmission using a first transmit power level that is higher than a maximum transmit power that is indicated to a UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles; and transmitting, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.
Aspect 2: The method of Aspect 1, wherein the first uplink transmission comprises at least one of: a sounding reference signal, or a physical uplink control channel.
Aspect 3: The method of any of Aspects 1-2, further comprising: receiving scheduling information for the second uplink transmission, the scheduling information indicating to use the second transmit power level.
Aspect 4: The method of any of Aspects 1-3, wherein the first uplink transmission carries an indication of at least one of: the one or more transmit power level statistics, or the one or more planned power headrooms, in one or more medium access control (MAC) control elements (CEs).
Aspect 5: The method of any of Aspects 1-4, further comprising: transmitting an indication of support for SAR-compliant power level management; and receiving configuration information that indicates to enable the SAR-compliant power level management.
Aspect 6: The method of Aspect 5, wherein the support for the SAR-compliant power level management comprises an ability to transmit at a higher power level relative to the maximum transmit power that is specified for the UE power class that is assigned to the UE.
Aspect 7: The method of Aspect 5 or Aspect 6, wherein the configuration information indicates to enable the SAR-compliant power level management for at least one of: a sounding reference signal, or a physical uplink control channel.
Aspect 8: The method of Aspect 7, wherein the configuration information comprises sounding reference signal (SRS) configuration information, wherein the SRS configuration information indicates a first SRS resource for SRS antenna switching (AS) and a second SRS resource for uplink multiple-input, multiple-output (MIMO) SRS, and wherein the configuration information indicates to enable the SAR-compliant power level management for the SRS AS and not for the uplink MIMO SRS.
Aspect 9: The method of Aspect 7, wherein the configuration information comprises sounding reference signal (SRS) configuration information, wherein the SRS configuration information indicates a shared SRS resource for SRS antenna switching (AS) and uplink multiple-input, multiple-output (MIMO) SRS, and wherein the configuration information indicates to enable the SAR-compliant power level management for the SRS AS and for the uplink MIMO SRS.
Aspect 10: The method of any of Aspects 1-9, wherein transmitting the second uplink transmission using the second transmit power level comprises: using a lower power level than a configured power level and without receiving scheduling information that indicates to use the second transmit power level.
Aspect 11: The method of any of Aspects 1-10, further comprising: transmitting a power headroom report that indicates one or more planned power headrooms that are based at least in part on at least one of: one or more scheduling rates, or one or more duty cycles.
Aspect 12: A method of wireless communication performed by a network node, comprising: receiving, within a specific absorption rate (SAR) time window, a first uplink transmission that uses a first transmit power level that is higher than a maximum transmit power that is indicated to a user equipment (UE) or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles; and receiving, within the SAR time window, a second uplink transmission that is associated with the UE, the second uplink transmission having a second transmit power level that is lower than a configured transmit power level for the second uplink transmission for an incoming part of the SAR time window, the second transmit power level being based at least in part on the first transmit power level and satisfying an SAR threshold.
Aspect 13: The method of Aspect 12, wherein the first uplink transmission comprises at least one of: a sounding reference signal, or a physical uplink control channel.
Aspect 14: The method of any of Aspects 12-13, further comprising: transmitting, based at least in part on receiving the transmit power level statistics, scheduling information for the second uplink transmission, wherein the scheduling information indicates to use the second transmit power level.
Aspect 15: The method of any of Aspects 12-14, wherein the first uplink transmission carries an indication of the one or more transmit power level statistics in a medium access control (MAC) control element (CE).
Aspect 16: The method of any of Aspects 12-15, further comprising: receiving an indication of support for SAR-compliant power level management; and transmitting configuration information that indicates to enable the SAR-compliant power level management.
Aspect 17: The method of Aspect 16, wherein the support for the SAR-compliant power level management comprises an ability to transmit at a higher power level relative to the maximum transmit power that is specified for the UE power class that is assigned to the UE.
Aspect 18: The method of Aspect 16 or Aspect 17, wherein the configuration information indicates to enable the SAR-compliant power level management for at least one of: a sounding reference signal, or a physical uplink control channel.
Aspect 19: The method of Aspect 18, wherein the configuration information comprises sounding reference signal (SRS) configuration information, wherein the SRS configuration information indicates a first SRS resource for SRS antenna switching (AS) and a second SRS resource for uplink multiple-input, multiple-output (MIMO) SRS, and wherein the configuration information indicates to enable the SAR-compliant power level management for the SRS AS and not for the uplink MIMO SRS.
Aspect 20: The method of Aspect 18, wherein the configuration information comprises sounding reference signal (SRS) configuration information, wherein the SRS configuration information indicates a shared SRS resource for SRS antenna switching (AS) and uplink multiple-input, multiple-output (MIMO) SRS, and wherein the configuration information indicates to enable the SAR-compliant power level management for the SRS AS and for the uplink MIMO SRS.
Aspect 21: The method of any of Aspects 12-20, wherein receiving the second uplink transmission using the second transmit power level comprises: receiving the second uplink transmission that uses the second transmit power level without transmitting scheduling information that indicates to use the second transmit power level.
Aspect 22: The method of any of Aspects 12-21, further comprising: computing an uplink measurement metric based at least in part on the first uplink transmission; computing an adjusted uplink measurement metric based at least in part on the one or more transmit power level statistics; and selecting a scheduling configuration for the second uplink transmission based at least in part on the adjusted uplink measurement metric.
Aspect 23: The method of Aspect 22, wherein selecting the scheduling configuration for the second uplink transmission comprises selecting a configured transmit power level based at last in part on at least one of: a scheduling rate, or the SAR threshold.
Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.
Aspect 25: An apparatus for wireless communication at a device, the apparatus comprising one or more memories and one or more processors coupled to the one or more memories, the one or more processors configured to cause the device to perform the method of one or more of Aspects 1-11.
Aspect 26: An apparatus for wireless communication, the apparatus comprising at least one means for performing the method of one or more of Aspects 1-11.
Aspect 27: A non-transitory computer-readable medium storing code for wireless communication, the code comprising instructions executable by one or more processors to perform the method of one or more of Aspects 1-11.
Aspect 28: A non-transitory computer-readable medium storing a set of instructions for wireless communication, the set of instructions comprising one or more instructions that, when executed by one or more processors of a device, cause the device to perform the method of one or more of Aspects 1-11.
Aspect 29: A device for wireless communication, the device comprising a processing system that includes one or more processors and one or more memories coupled with the one or more processors, the processing system configured to cause the device to perform the method of one or more of Aspects 1 -11.1
Aspect 30: An apparatus for wireless communication at a device, the apparatus comprising one or more memories and one or more processors coupled to the one or more memories, the one or more processors individually or collectively configured to cause the device to perform the method of one or more of Aspects 1-11.
Aspect 31: A device comprising a processing system that includes one or more processors and one or more code-storing memories coupled with the one or more processors, the processing system configured to cause the device to perform the method of one or more of Aspects 1-11.
Aspect 32: A device comprising a processing system that includes processor circuitry and code-storing memory circuitry, the processing system configured to cause the device to perform the method of one or more of Aspects 1-11.
Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 12-23.
Aspect 34: An apparatus for wireless communication at a device, the apparatus comprising one or more memories and one or more processors coupled to the one or more memories, the one or more processors configured to cause the device to perform the method of one or more of Aspects 12-23.
Aspect 35: An apparatus for wireless communication, the apparatus comprising at least one means for performing the method of one or more of Aspects 12-23.
Aspect 36: A non-transitory computer-readable medium storing code for wireless communication, the code comprising instructions executable by one or more processors to perform the method of one or more of Aspects 12-23.
Aspect 37: A non-transitory computer-readable medium storing a set of instructions for wireless communication, the set of instructions comprising one or more instructions that, when executed by one or more processors of a device, cause the device to perform the method of one or more of Aspects 12-23.
Aspect 38: A device for wireless communication, the device comprising a processing system that includes one or more processors and one or more memories coupled with the one or more processors, the processing system configured to cause the device to perform the method of one or more of Aspects 12-23.
Aspect 39: An apparatus for wireless communication at a device, the apparatus comprising one or more memories and one or more processors coupled to the one or more memories, the one or more processors individually or collectively configured to cause the device to perform the method of one or more of Aspects 12-23.
Aspect 40: A device comprising a processing system that includes one or more processors and one or more code-storing memories coupled with the one or more processors, the processing system configured to cause the device to perform the method of one or more of Aspects 12-23.
Aspect 41: A device comprising a processing system that includes processor circuitry and code-storing memory circuitry, the processing system configured to cause the device to perform the method of one or more of Aspects 12-23.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, within a specific absorption rate (SAR) time window, a first uplink transmission using a first transmit power level that is higher than a maximum transmit power that is indicated to the UE or is associated with a UE power class of the UE, the first uplink transmission indicating at least one of:
one or more transmit power level statistics that are associated with the SAR time window, or
one or more planned transmit power levels, the one or more planned transmit power levels being based at least in part on at least one of:
one or more scheduling rates,
one or more duty cycles; and
transmit, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

2. The UE of claim 1, wherein the first uplink transmission comprises at least one of:
a sounding reference signal, or
a physical uplink control channel.

3. The UE of claim 1, wherein the processing system is configured to cause the UE to:
receive scheduling information for the second uplink transmission, the scheduling information indicating to use the second transmit power level.

4. The UE of claim 1, wherein the processing system is configured to cause the UE to:
transmit a power headroom report that indicates one or more planned power headrooms that are based at least in part on at least one of:
one or more scheduling rates, or
one or more duty cycles.

5. The UE of claim 1, wherein the first uplink transmission carries an indication of at least one of:
the one or more transmit power level statistics, or
the one or more planned power headrooms,
in one or more medium access control (MAC) control elements (CEs).

6. The UE of claim 1, wherein the processing system is configured to cause the UE to:
transmit an indication of support for SAR-compliant power level management; and
receive configuration information that indicates to enable the SAR-compliant power level management.

7. The UE of claim 5, wherein the support for the SAR-compliant power level management comprises an ability to transmit at a higher power level relative to the maximum transmit power that is specified for the UE power class that is assigned to the UE.

8. The UE of claim 5, wherein the configuration information indicates to enable the SAR-compliant power level management for at least one of:
a sounding reference signal, or
a physical uplink control channel.

9. The UE of claim 7, wherein the configuration information comprises sounding reference signal (SRS) configuration information,
wherein the SRS configuration information indicates a first SRS resource for SRS antenna switching (AS) and a second SRS resource for uplink multiple-input, multiple-output (MIMO) SRS, and
wherein the configuration information indicates to enable the SAR-compliant power level management for the SRS AS and not for the uplink MIMO SRS.

10. The UE of claim 7, wherein the configuration information comprises sounding reference signal (SRS) configuration information,
wherein the SRS configuration information indicates a shared SRS resource for SRS antenna switching (AS) and uplink multiple-input, multiple-output (MIMO) SRS, and wherein the configuration information indicates to enable the SAR-compliant power level management for the SRS AS and for the uplink MIMO SRS.

11. The UE of claim 1, wherein the processing system, to cause the UE to transmit the second uplink transmission using the second transmit power level, is configured to cause the UE to:
use a lower power level than a configured power level and without receiving scheduling information that indicates to use the second transmit power level.

12. A method of wireless communication performed by a user equipment (UE), comprising:
transmitting, within a specific absorption rate (SAR) time window, a first uplink transmission using a first transmit power level that is higher than a maximum transmit power that is indicated to the UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles; and
transmitting, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

13. The method of claim 12, further comprising:
receiving scheduling information for the second uplink transmission, the scheduling information indicating to use the second transmit power level.

14. The method of claim 12, wherein the first uplink transmission carries an indication of the one or more transmit power level statistics in a medium access control (MAC) control element (CE).

15. The method of claim 12, further comprising:
transmitting an indication of support for SAR-compliant power level management; and
receiving configuration information that indicates to enable the SAR-compliant power level management.

16. The method of claim 2, wherein transmitting the second uplink transmission using the second transmit power level comprises:
using a lower power level than a configured power level and without receiving scheduling information that indicates to use the second transmit power level.

17. A non-transitory computer-readable medium storing a set of instructions for wireless communication, the set of instructions comprising:
one or more instructions that, when executed by one or more processors of a user equipment (UE), cause the UE to:
transmit, within a specific absorption rate (SAR) time window, a first uplink transmission using a first transmit power level that is higher than a maximum transmit power that is indicated to the UE or is associated with a UE power class of the UE, the first uplink transmission indicating at least one of: one or more transmit power level statistics that are associated with the SAR time window, or one or more planned transmit power levels, the one or more planned transmit power levels being based at least in part on at least one of: one or more scheduling rates, or one or more duty cycles; and
transmit, within the SAR time window, a second uplink transmission using a second transmit power level that is lower than a configured transmit power level for the second uplink transmission for an incoming part of the SAR time window, the second transmit power level being based at least in part on the first transmit power level and satisfying an SAR threshold.

18. The non-transitory computer-readable medium of claim 17, wherein the one or more instructions further cause the UE to: transmit an indication of support for SAR-compliant power level management; and
receive configuration information that indicates to enable the SAR-compliant power level management.

19. The non-transitory computer-readable medium of claim 18, wherein the one or more instructions further cause the UE to receive, as the configuration information, sounding reference signal (SRS) configuration information,
wherein the SRS configuration information indicates a first SRS resource for SRS antenna switching (AS) and a second SRS resource for uplink multiple-input, multiple-output (MIMO) SRS, and
wherein the configuration information indicates to enable the SAR-compliant power level management for the SRS AS and not for the uplink MIMO SRS.

20. The non-transitory computer-readable medium of claim 18, wherein the one or more instructions further cause the UE to receive, as the configuration information, sounding reference signal (SRS) configuration information,
wherein the SRS configuration information indicates a shared SRS resource for SRS antenna switching (AS) and uplink multiple-input, multiple-output (MIMO) SRS, and wherein the configuration information indicates to enable the SAR-compliant power level management for the SRS AS and for the uplink MIMO SRS.
